(19) United States
(12) Patent Application Publication
(10) Pub. No.: US 2019/0028832 A1
(43) Pub. Date: Jan. 24, 2019

(54) Sender device comtrolled data geographical location fencing method and system

(71) Applicant: Claremont Speede, Brandywine, MD (US)

(72) Inventor: Claremont Speede, Brandywine, MD (US)

(21) Appl. No.: 15/731,715

(22) Filed: Jul. 21, 2017

(51) Int. Cl. H04W 4/00; H04W 4/02; G08B 1/08; H04L 12/58; G06F 17/30

(52) U.S. Cl. CPC H04W 4/006; H04W 4/021; G06F 17/30; H04L 51/14; G08B 1/08

(57) ABSTRACT

A method and system are provided for remotely restricting data stored on the remote mobile communication device, sensor, or Internet of Things (IoT) device, by initiating a geographical restricting command when creating the data from a data originating mobile communication device, sensor or Internet of Things (IoT) device.

### CROSS-REFERENCES TO RELATED APPLICATIONS

This application is a continuation of U.S. patent application Ser. No. 13/998,024, filed Sep. 24, 2013, entitled MOBILE SENDER CONTROLLED DATA ACCESS AND DATA DELETION METHOD AND SYSTEM by SPEEDE, Claremont, which claims benefit of U.S. Provisional Ser. No. 61/744,332, filed on Sep. 24, 2012, and entitled MOBILE SENDER CONTROLLED DATA ACCESS AND DATA DELETION METHOD AND SYSTEM, the specifications of which are incorporated herein by reference in their entirety.

### BACKGROUND—PRIOR ART

The following is a tabulation of some prior art that presently appears relevant:

U.S Patents

| Pat. No. | Kind Code | Issue Date | App or Patentee |
|---|---|---|---|
| 9,351,107 | B2 | May 24, 2016 | Ankit Nigam |
| 8,423,791 | B1 | Apr. 16, 2013 | Yan Yu |
| 8,510,773 | B1 | Aug. 13, 2013 | Mitri Abou-Rizk |
| 8,538,685 | B2 | Sep. 17, 2013 | William J. Johnson |
| 8,578,274 | B2 | Nov. 5, 2013 | Adrian Druzgalski |
| 8,700,003 | B2 | Apr. 15, 2014 | Elliot Klein |
| 8,718,598 | B2 | May 6, 2014 | William J. Johnson |
| 8,744,230 | B2 | Jun. 3, 2014 | Gregory R. Hovagim |
| 8,775,328 | B1 | Jul. 8, 2014 | Raj Abhyanker |
| 8,850,473 | B2 | Sep. 30, 2014 | Patrick Sheehan |
| 8,971,930 | B2 | Mar. 3, 2015 | Andrew Andrey Li |
| 8,983,978 | B2 | Mar. 17, 2015 | Eswar Priyadarshan |
| 9,537,869 | B2 | Jan. 3, 2017 | Erik L. Peterson |

Existing geo-fenced location systems do not allow the sender of the data to have control over the geographical location of the receiver of the data. Existing geo-fenced location solutions are controlled by a central location, outside the control of the actual data creator. With existing geo-fencing location systems, the restrictions placed on roaming capabilities of the receiver device is left to a central system, a carrier and or the actual receiver device.

Accordingly, what is desired is a method for enabling the data sender, originating mobile communication device, a sensor or an Internet of Things (IoT) device, to have the capability to set, at its own convenience, the geographical location fencing of their sent data, before the data is sent to the potentially geographical roaming receiver mobile communication device, sensor or Internet of Things (IoT) device. Data, in binary or ASCII format, could be feature configurations for an IoT device, adding or restricting capabilities of a device based on the sensor's geographical location.

### FIELD OF THE INVENTION

The present invention generally relates to methods and a data delivery storage system, and more particularly, to methods and a data delivery storage system for enabling the data sender, originating mobile communication device, a sensor or an Internet of Things (IoT) device, to have the capability to set, at its own convenience, the geographical location fencing of their sent data, before the data is sent to the potentially geographical roaming receiver mobile communication device, sensor or Internet of Things (IoT) device.

### BACKGROUND OF INVENTION

Concerns about exposure of what was assumed to be confidential exchanges of information, has been the subject of debates aired over the media. It has become obvious that information, once transmitted, may be viewed by third parties along the data communication pathway and by others, the data receiver may choose to disclose it to. Many forms of data and communication encryption strategies address the communication pathway disclosure issue, but the end user receiver disclosure still exists. In the mobile space, this problem is magnified several times, due to the obvious transient nature of end users. For example, the sender of the data has no control over, or knowledge of the geographical location of the receiver of the data, after it has been sent. With existing geo-fencing location systems, the restrictions placed on roaming capabilities of the receiver device is left to a central system, GPS, cellular or WiFi location technologies. This scenario adds to the problem of information leakage, multi-regional compliance issues and reduced operational governance control, which remains an issue even if the line of transmission is secure.

Elaborate security schemes are available to ensure confidentiality, compliance and operational governance control are ensured. However, the mobile recipient is not considered to be a member of the group of links, in the security chain, that may pose as a concern. For example, a sender transmits an encrypted data to a mobile receiver, who successfully receives it; however as he is in transit, migrates to a geographical location that is outside of the sender's sanctioned zone for such data sensitivity level. The data migrating outside of an allowed geographical zone, set by the data creator, may be a compliance or governance concern. As another example, a data sender, such as an originating sensor or an Internet of Things (IoT) device, could have the capability to set, at its own convenience, the geographical location fencing of its sent data, before the data is sent to a potentially geographical roaming receiver mobile communication device, sensor or Internet of Things (IoT) device. Data, in binary or ASCII format, could be feature configurations for the receiver device, adding or restricting capabilities of the device based on the sensor's geographical location.

Therefore, improvements for mobile device, sensor or Internet of Things (IoT) device communication and a method for managing sent data, by the data sender device, or owner, are needed in the industry to address the aforementioned deficiencies.

### BRIEF SUMMARY OF THE INVENTION

Embodiments of the present invention provide techniques that enable a sender, using a mobile communication device, sensor or Internet of Things (IoT) device to control the geographical location of the mobile communication device, sensor or Internet of Things (IoT) device at the moment of receiving the sent data, and after the data is stored. Essentially quarantining the sent data to a geographical location defined by the sending device, thus geo-fencing the source data. When a receiver attempts to roam to a geographical location outside of the data sender's defined limits, the receiver device will not be able to receive the sent data. At this point, the sender may be notified that the receiving device has migrated outside of the allowed sender defined geographical location. If the data is already stored on the receiver device, and the device migrates outside the sender's allowed geographical location, the stored data is deleted.

A further understanding of the nature and advantages of the invention herein may be realized by reference of the remaining portions in the specifications and the attached drawings.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a mobile communication device, a sensor or an Internet of Things (IoT) device sender controlled data geographical location fencing network, in accordance with an embodiment of the present invention.

FIG. 2 illustrates communication channels in a mobile communication device, a sensor or an Internet of Things (IoT) device sender controlled data geographical location fencing network, in accordance with an embodiment of the present invention.

FIG. 3 is a flowchart depicting steps in the operation of a mobile communication device, a sensor or an Internet of Things (IoT) device sender controlled data geographical location fencing delivery storage system, in accordance with an embodiment of the present invention.

FIG. 4A and FIG. 4B combined, is a flowchart depicting steps in the operation of the process info process in a mobile communication device, a sensor or an Internet of Things (IoT) device sender controlled data geographical location fencing delivery storage system, in accordance with an embodiment of the present invention.

FIG. 5 is a flowchart depicting steps in the operation the authentication process residing in a mobile communication device, a sensor or an Internet of Things (IoT) device sender controlled data geographical location fencing delivery storage system, in accordance with an embodiment of the present invention.

FIG. 6A and FIG. 6B combined, is a flowchart depicting steps of a client service for a mobile communication device, a sensor or an Internet of Things (IoT) device sender controlled data geographical location fencing delivery storage system, in accordance with an embodiment of the present invention.

FIG. 7 is a flowchart depicting steps of the execution process of data in a client service for a mobile communication device, a sensor or an Internet of Things (IoT) device sender controlled data geographical location fencing delivery storage system, in accordance with an embodiment of the present invention.

### DETAILED DESCRIPTION OF THE INVENTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

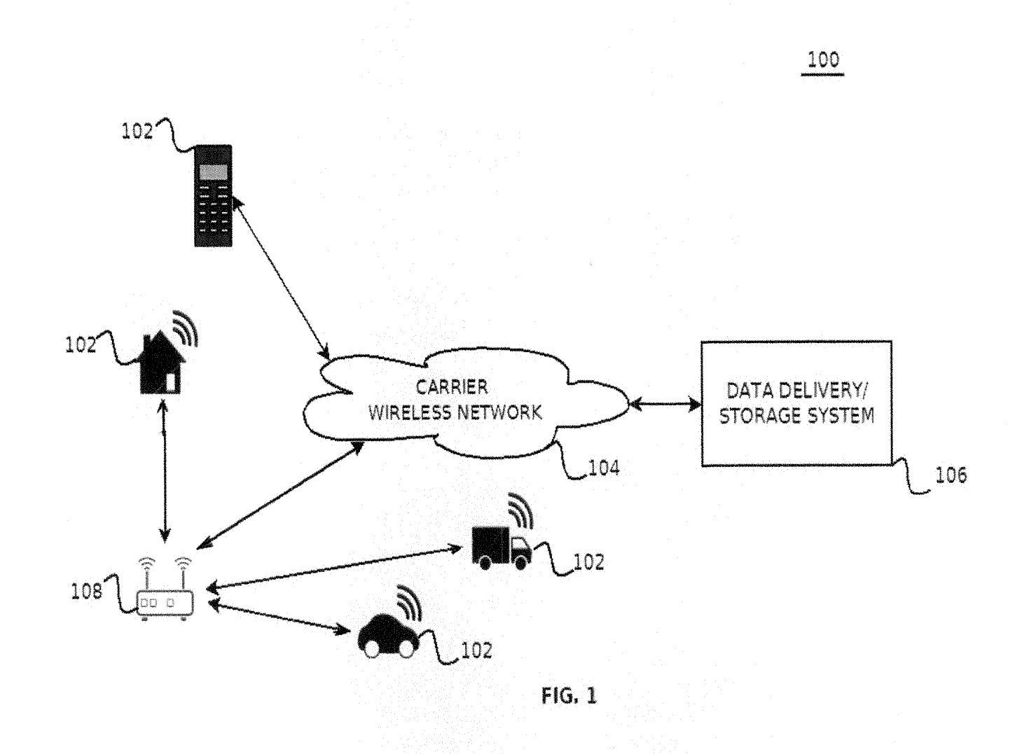

FIG. 1 is a network 100 depicting a mobile communication device, a sensor, or an Internet of Things (IoT) device sender controlled data geographical location fencing delivery storage network, in accordance with an embodiment of the present invention. The network 100 includes a user device 102, a carrier wireless network 104, a Cellular M2M Network or LoRa Gateway 108, and a data delivery storage system 106. As used in this specification, user device 102 will commonly be a mobile communication device, a sensor, or an Internet of Things (IoT) device having data communication capabilities, although one skilled in the relevant arts will readily appreciate that any communication device, or device having communication capabilities, can be substituted. Similarly, network 104 will commonly be a carrier wireless network throughout this specification, although one skilled in the relevant arts will likewise appreciate that, depending on the capabilities of user device 102, other network types, to include wired networks of any type, or wireless technology of any type (e.g., Bluetooth, cellular, wi-fi, Low Power Wide Area Network (LPWAN), such as LoRa LPWAN, Cellular M2M Network or LoRa LP Private Network, ad hoc, etc.), can be substituted for wireless network 104.

Data delivery storage system 106 eases the communications between sender and receiver user devices 102, by routing and storing data from sender user device 102 to receiver user device 102, as further disclosed below, in accordance with an embodiment of the present invention. Furthermore, data delivery storage system 106 includes logic for establishing communications with user device 102 over carrier wireless network 104, and Cellular M2M Network or LoRa Gateway 108 in accordance with an embodiment of the present invention. Carrier wireless network 104 and Cellular M2M Network or LoRa Gateway 108 is, in accordance with an additional embodiment of the present invention, a cellular communications network.

### II. Network Communications

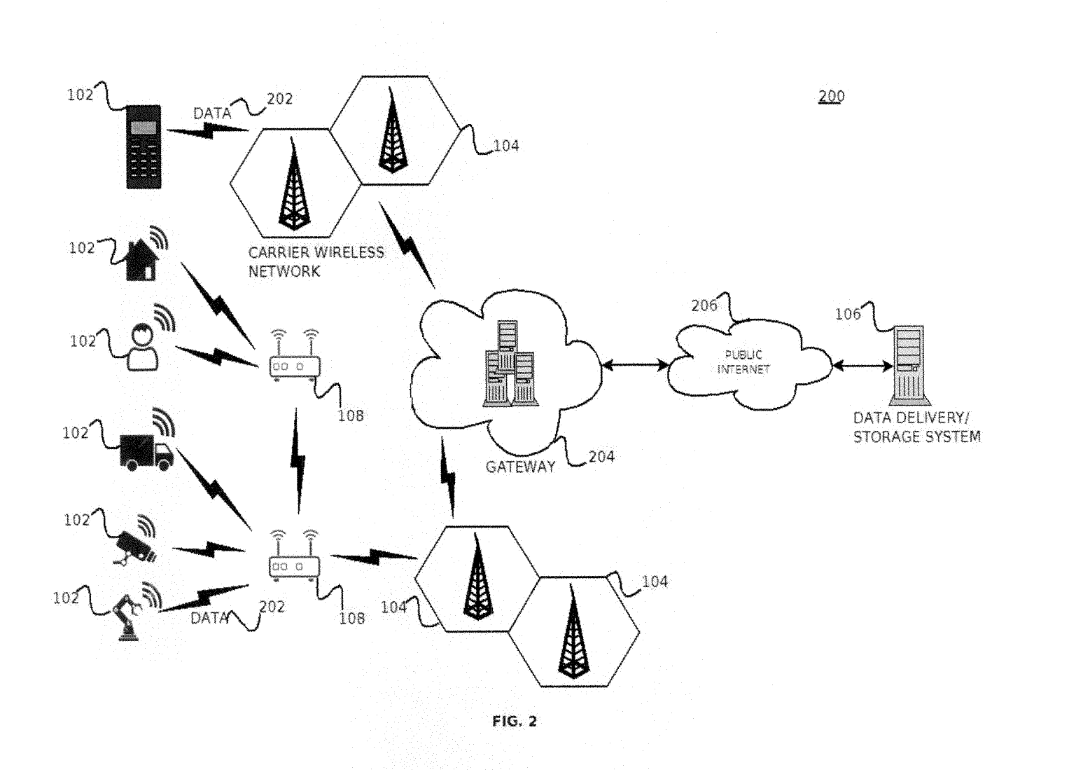

FIG. 2 is a network 200 illustrating communication channels in a mobile communication device, a sensor or an Internet of Things (IoT) device sender controlled data geographical location fencing network, in accordance with an embodiment of the present invention. As previously disclosed, a user device 102 is operable to connect to a data delivery storage system 106 over carrier wireless network 104 and Cellular M2M Network or LoRa Gateway 108 in order to send and receive data. One skilled in the relevant arts will recognize that a user device 102, such as a mobile communication device, a sensor, or an Internet of Things (IoT) device, can communicate using a number of different protocols over a carrier wireless network 104 and Cellular M2M Network or LoRa Gateway 108, such as a cellular communications network.

In accordance with an embodiment of the present invention, user device 102 is configured to transmit data of any type over carrier wireless network 104. A carrier gateways 204 are used to receive the data 202 communications from carrier wireless network 104 and forward the communications to data delivery storage system 106, in accordance with an embodiment of the present invention. In accordance with an additional embodiment of the present invention, gateways 204 is a carrier Gateway GPRS Support Node (GGSN) and an SMS gateway Clickatell provided by Clickatell (Pty) Ltd., of Redwood City, Calif. One skilled in the relevant arts will recognize that the precise configuration of the gateways 204 as shown in FIG. 2 need not exist in every system, where instead other means for forwarding the data 202 communications to data delivery system 106 are implemented.

In accordance with an embodiment of the present invention, user device 102 transmits data 202 to gateways 204 through the use of a special “short code” and Internet protocol address assigned to the data delivery storage system 106, in order to allow gateways 204 to properly route the data 202 to the data delivery system 106.

### III. Operation of the Data Delivery Storage System

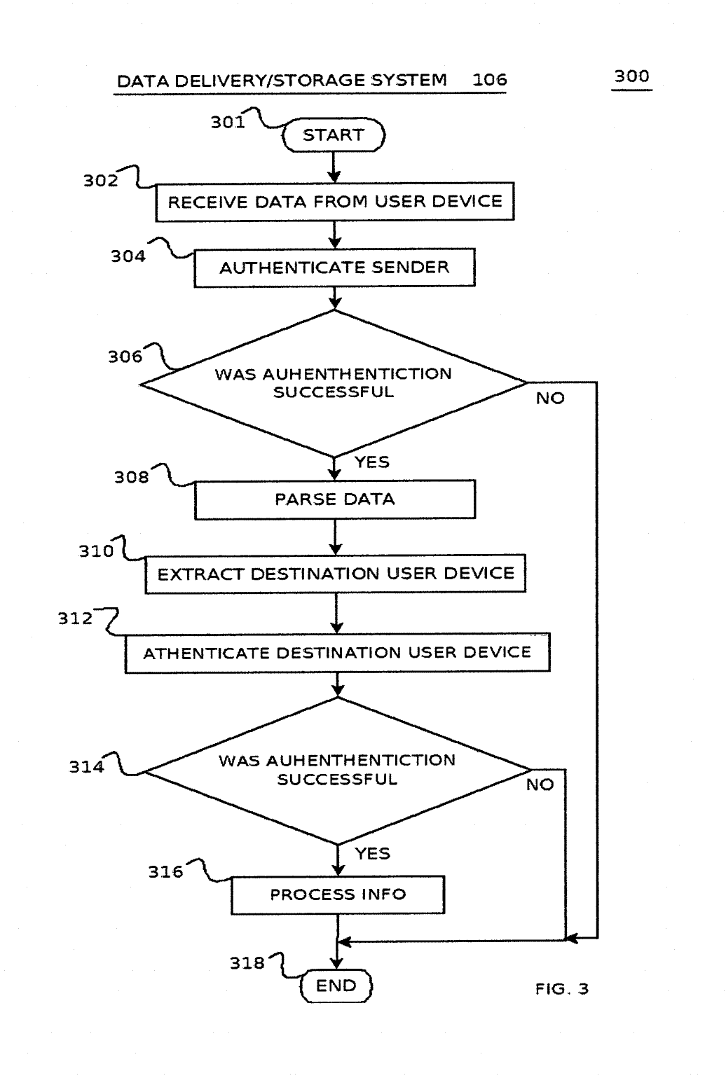

FIG. 3 is a flowchart 300 depicting an operational flow of data delivery storage system 106, in accordance with an embodiment of the present invention. Flowchart 300 method begins at step 301 and proceeds to step 302, where the data delivery storage system 106 receives data 202 from the user device 102. At step 304, the data delivery system 106 performs authentication on the sender user or user device 102, then process proceeds to step 306. If authentication was unsuccessful 306, the method proceeds to step 318 where processing ends. If authentication was successful 306, the method continues to step 308.

At step 308 of flowchart 300, of the data delivery storage system 106, the data 202 is parsed. In the process of parsing the data 202, the intended destination user or user device 102 from some received data 202 is extracted 310. Once extraction 310 is complete, step 312 of the data delivery storage system 106 performs authentication on the destination user or user device 102, then process proceeds to step 314. If authentication was unsuccessful 314, the method proceeds to step 318 where processing ends. If authentication was successful 314, the method continues to step 316.

At step 316 of flowchart 300, the message delivery storage system 106, the parsed data 202 is then repackaged into a data 202 format, and transmitted to the intended destination user or user device 102, as further disclosed below, in accordance with an embodiment of the present invention. The method ends at step 318, in accordance with an embodiment of the present invention.

With continued reference to flowchart 300 of FIG. 3, the data delivery storage system 106, and network 200 of FIG. 2, an example user interaction with the data delivery storage system 106 is disclosed, in accordance with an embodiment of the present invention. A user creates data (binary, ASCII, or any file type), at user device 102 to be delivered to a remote user device 102. In this example, the user creates data. The user then sends this data to the remote user mobile device 102 by entering a mobile number associated with the remote user mobile device 102. In accordance with an embodiment of the present invention, the data is sent to a short code, such as 45772, that uniquely identifies data delivery storage system 106.

At step 302 of flowchart 300, the data delivery system 106 receives the data 202, and at steps 304 and 312 the data delivery system 106 performs any necessary authentication, as will be fully disclosed herein. If authentications are unsuccessful 306 and 314, the process proceeds to step 318. If authentications are successful 306 and 314, the process continues to step 308 and 316, respectively.

At step 308 of flowchart 300, the data delivery system 106 begins parsing the data to identify a token, or tokens in the aforementioned data, which represents the destination user or user device 102 from some received data 202, in accordance with an embodiment of the present invention. Next, this token is extracted 310 and step 312 of the data delivery storage system 106, performs authentication on the destination user or user device 102. If authentication was unsuccessful 314, the method proceeds to step 318 where processing ends. If authentication was successful 314, the method continues to step 316.

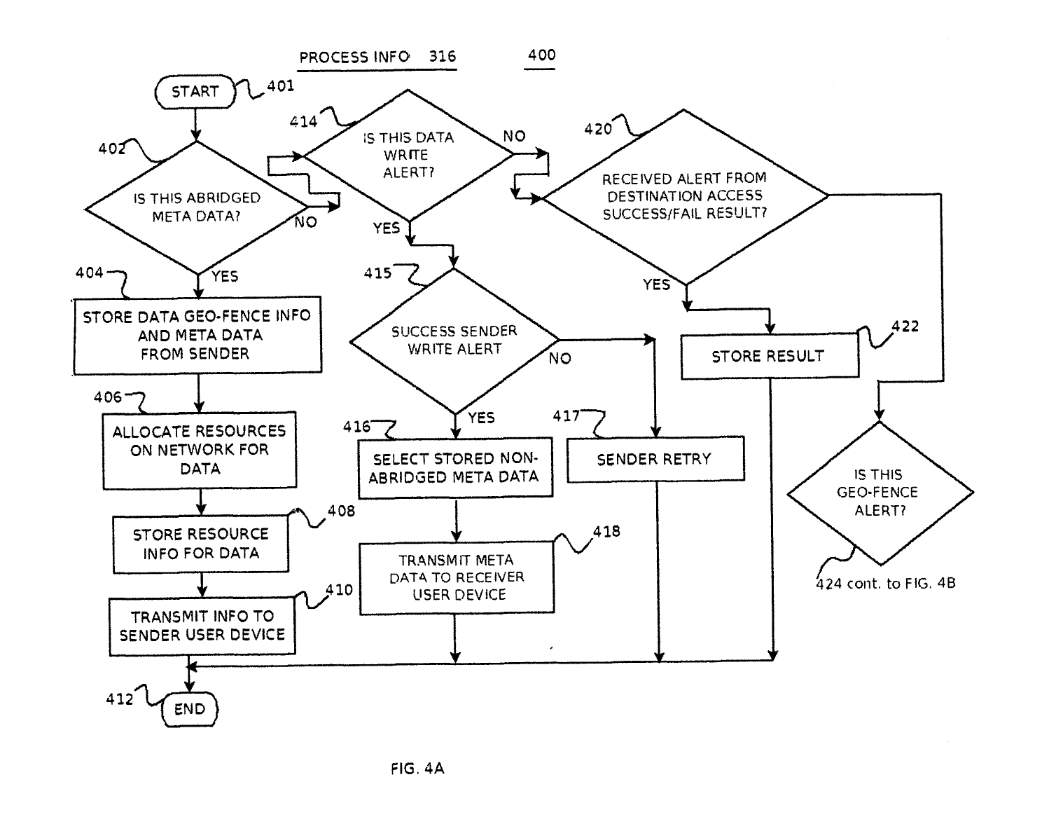

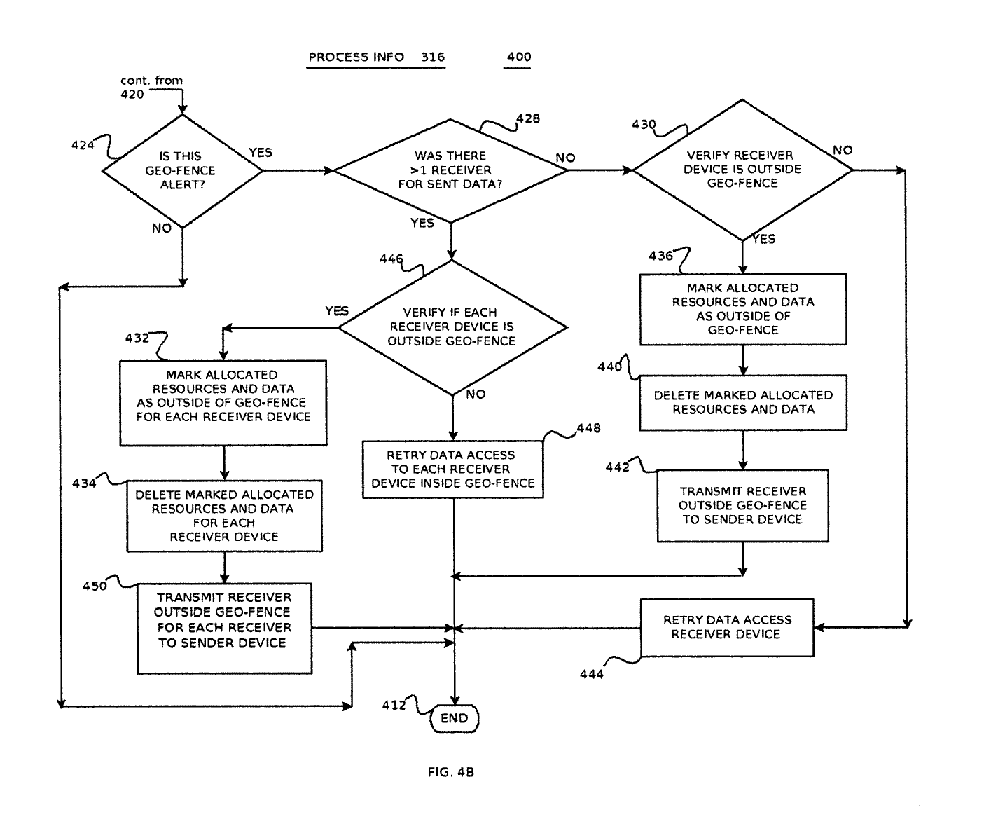

At step 316 of flowchart 300, the data delivery system 106, the data is processed, which is described in more detail in FIG. 4, in accordance with an embodiment of the present invention.

In accordance with an additional embodiment of the present invention, if the authentication of steps 306 and 314 fails, the process flow is terminated. In accordance with a further embodiment of the present invention.

### IV. Process Information

FIG. 4A and FIG. 4B combined, is a flowchart 400 depicting a process info flow of the data delivery storage system 106, in accordance with an embodiment of the present invention. The method begins at step 401 and proceeds to step 402, where the data delivery storage system 106 processes data 202 received from the user device 102. At step 402, the data delivery storage system 106 determines if the data is abridged meta data. If data is abridged meta data, then process proceeds to step 404. If data is not abridged meta data, the method proceeds to step 414, which is described in more detail below. Meta data is a set of data that describes and gives information about other data. Abridged meta data is information pertaining to what type of data will be sent, the geographical location fencing data, configured by sender user device 102, and an actual fingerprint or unique marker of the data that will be sent. Non-abridged meta data is the resource or file system information that is linked to the abridged data that includes details such as storage or location information. If a receiver device is outside of the sender created geo-fence, the linked meta data, abridged and non-abridged, is automatically removed from the data delivery system 106 during the deletion process. At step 404, the data delivery storage system 106 stores the meta data, and the geographical location fencing, geo-fence data, sent from the sender user device 102. Next, the data delivery storage system 106 allocates network resources for data at step 406. Allocated network resources is the entity which stores the data for example, a hard drive, networked drive, external drive or a cloud system that stores the data. The network resources is a directory of the data. The data delivery storage system 106 then proceeds to step 408. At step 408, the data delivery storage system 106 stores the allocated network resource information. Next, the data delivery system 106 transmits the resource information at step 410 to the sender user device 102. The method then proceeds to step 412 where processing ends.

At step 414, the data delivery storage system 106 determines if the data 202 is a data write success alert. If data is a data write success alert, then process proceeds to step 415. If data is not a data write success alert, the method proceeds to step 420, which is described in more detail below. At step 415, the data delivery storage system 106 determines if the sender user device 102 successfully wrote data 202 to the data delivery storage system 106 from the received alert. If the write was successful, then process proceeds to step 416. If the write was unsuccessful, the method proceeds to step 417, which is described in more detail below. At step 416, the data delivery storage system 106 selects the stored non-abridged meta data created for the sender user device 102. Next, the data delivery storage system 106 transmits non-abridged meta data to the receiver user device 102 at step 418. The method then proceeds to step 412 where processing ends. At step 417, the data delivery storage system 106 indicates the sender use device 102 will attempt to rewrite data 202. The method then proceeds to step 412 where processing ends.

At step 420, the data delivery storage system 106 determines if the data 202 is an alert that the receiver user device 102 accessed sent data. If data 202 was accessed, then the method proceeds to step 422. If data 202 was not successfully accessed by the receiver user device 102, then the method proceeds to step 424, which is illustrated and described in more detail in FIG. 4B. At step 422, the data delivery storage system 106 stores the result of the receiver user device's 102 access of the locally stored data 202. The method then proceeds to step 412 where processing ends.

The method continues in FIG. 4B at step 424 of flowchart 400 from step 420, where the data delivery storage system 106 determines if the data 202 was geo-fenced by the sender user device 102. If the data 202 was geo-fenced, then the method proceeds to step 428. If the data 202 was not geo-fenced by the sender user device 102, then the method proceeds to step 412 where processing ends.

At step 428, the data delivery storage system 106 determines the number of receiver user devices 102 that successfully accessed data 202. If the number of receiver user devices 102 that accessed the data 202 is greater than one, then the method proceeds to step 446. If only one receiver user device 102 accessed the data 202, then the method proceeds to step 430.

At step 446, the data delivery storage system 106 determines if each of the receiver user device 102 is outside of the geo-fenced location created by the sender user device 102. If the receiver user device 102 is outside of the geo-fenced location, then the method proceeds to step 432. If the receiver user device 102 is within of the geo-fenced location, then the method proceeds to step 448.

At step 432, the data delivery storage system 106 flag for deletion the data 202 from the allocated resources whose receiver user device 102 is outside the designated geographical location. The method then proceeds to step 434.

At step 434, the data delivery storage system 106 deletes the data 202 from the allocated resources that was marked for deletion. Next, the data delivery storage system 106 sends a receiver outside of geo-fence for each receiver that is outside the designated geographical location to the sender user device 102, at step 450. The method then proceeds to step 412 where processing ends.

At step 448, the data delivery storage system 106 sends a retry data access alert to each receiver device 102 that is inside the designated geographical location. The method then proceeds to step 412 where processing ends.

At step 430, the data delivery storage system 106 determines if the receiver user device 102 is outside of the geo-fenced location created by the sender user device 102. If the receiver user device 102 is outside of the geo-fenced location, then the method proceeds to step 436. If the receiver user device 102 is within of the geo-fenced location, then the method proceeds to step 444.

At step 436, the data delivery storage system 106 flag for deletion the data 202 from the allocated resources whose receiver user device 102 is outside the designated geographical location. The method then proceeds to step 440.

At step 440, the data delivery storage system 106 deletes the data 202 from the allocated resources that was marked for deletion. Next, the data delivery storage system 106 sends a receiver outside of geo-fence for the receiver that is outside the designated geographical location to the sender user device 102, at step 442. The method then proceeds to step 412 where processing ends.

At step 444, the data delivery storage system 106 sends a retry data access alert to the receiver device 102 that is inside the designated geographical location. The method then proceeds to step 412 where processing ends.

### V. Operation of the Authentication Process

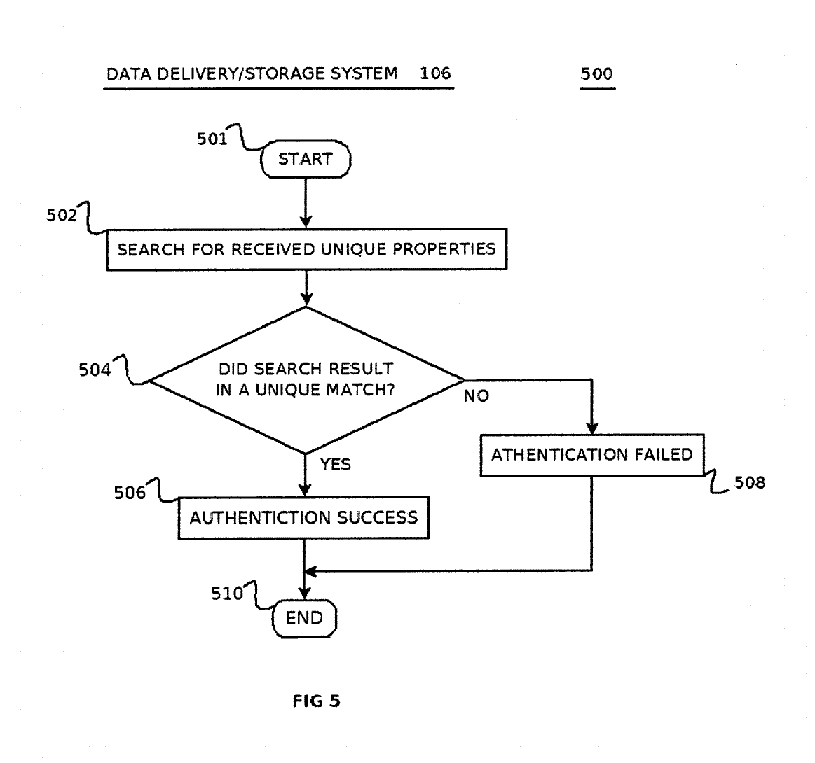

FIG. 5 is a flowchart 500 depicting an operational flow of the authentication process of the data delivery storage system 106, in accordance with an embodiment of the present invention. The method begins at step 501 and proceeds to step 502, where a search is performed in order to determine if the received unique properties can be found. The result is passed to step 504, in accordance with an embodiment of the present invention. At step 504, it is determined if the result is a valid user, by returning success and proceeding to step 506, if indeed the result is a valid user. Step 504 proceeds to step 508, if the result is determined not to be a valid user, in accordance with an embodiment of the present invention. The process then proceeds to step 510, where it ends.

One skilled in the relevant arts will appreciate that additional means for authentication can be used, and the aforementioned means are described by way of example and not limitation.

### VI. User Device Client Service

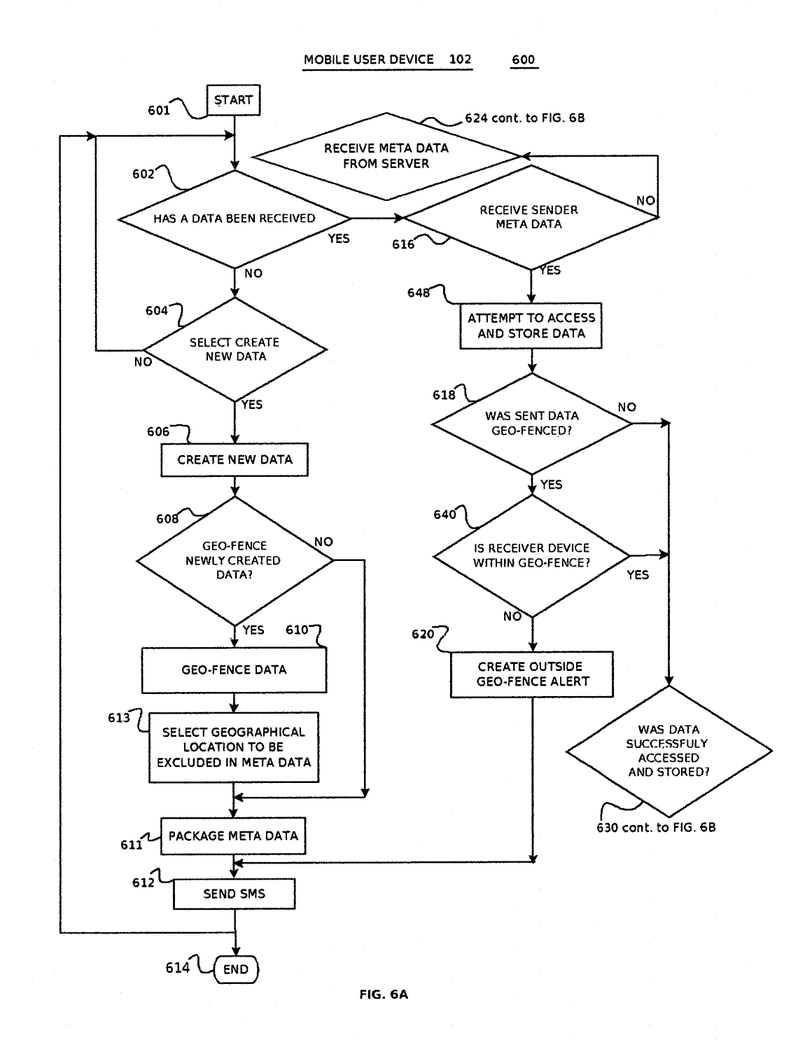

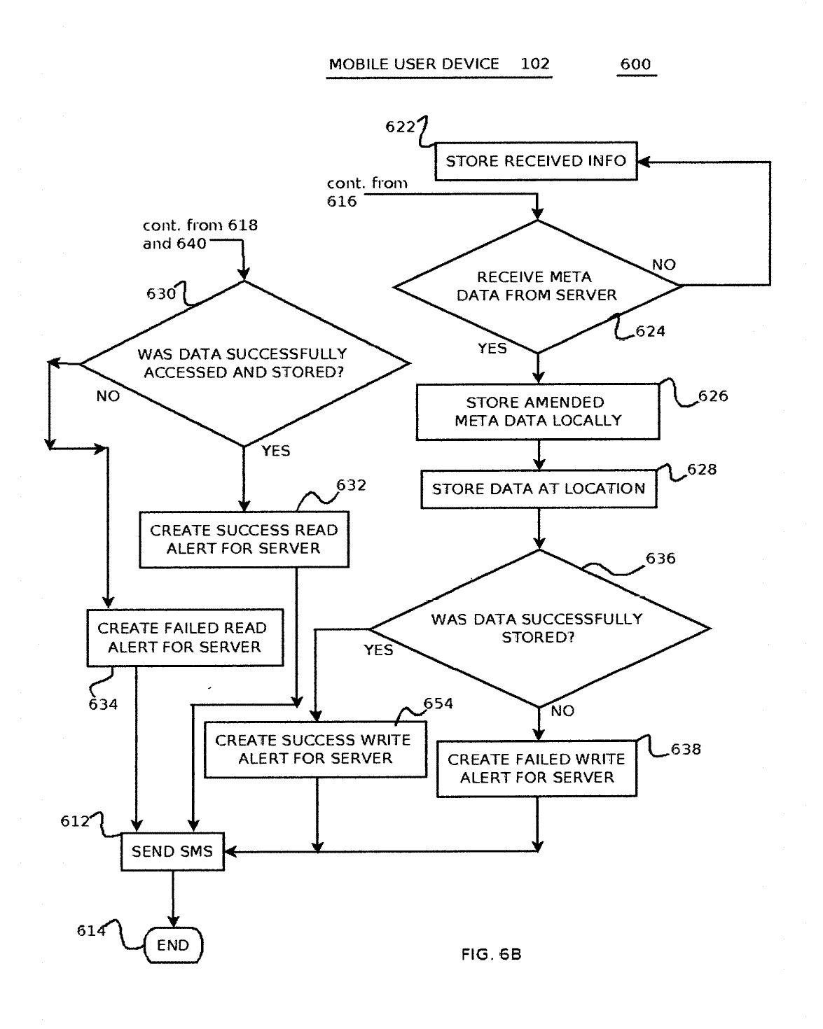

FIG. 6A and FIG. 6B combined, is a flowchart 600 depicting an operational flow of client service on the user device 102, in accordance with an embodiment of the present invention, of transmitting and receiving data (binary, ASCII, or any file type) 202, where by a sender user device 102 can control the geographical location fencing of sent data 202, on a remote receiver user device 102. The method begins in FIG. 6A at step 601 and proceeds to step 602, where the user device 102 receives data 202 sent from a sender user device 102. At step 602, the remote receiver user device 102 performs a check to verify if data 202 was received. If no data 202 was received, the method proceeds to step 604. If data 202 was received, the proceeds to step 616, which is described in more detail below, in accordance with an embodiment of the present invention.

At step 604 of flowchart 600, the client service, on the user device 102, verifies if create new data option is selected, or create new data from a list of data templates on the user device 102, in accordance with an embodiment of the present invention. If it was not selected, step 604 continues to step 602. If it was selected, the method proceeds to step 606. At step 606, new data is created, or create new data from a list of data templates on the user device 102, in accordance with an embodiment of the present invention. Once the data is created, the method continues to step 608.

At step 608 of flowchart 600, the client service, on the user device 102, verifies if a geographical location fencing, geo-fence, is to be set on the data 202 when it is sent on the remote user device 102, in accordance with an embodiment of the present invention. If no geographical location fencing, geo-fence, is to be set, the method continues to step 611, which packages the meta data, in accordance with an embodiment of the present invention. Once the meta data is created, the method continues to step 612. If geographical location fencing, geo-fence, is to be set on the data 202, the method continues to step 610 where the data 102 is marked for geographical location fencing, geo-fencing. The method then continues to step 613 where the geo-fence is created by selecting the geographical locations the data 102 is restricted from being transmitted to.

At step 612 of flowchart 600, the client service, on the user device 102, and transmits data 202 to the carrier wireless network 104, in accordance with an embodiment of the present invention. The process then proceeds to step 614, where it ends.

At step 616 of flowchart 600, the client service on the user device 102, signals that a data 202 is meta data sent from the sender user device 102. The process then proceeds to step 648. If data 202 is not meta data, then the process proceeds to 624, which is illustrated and described in more detail in FIG. 6B.

At step 648 of flowchart 600, the client service, on the user device 102, the data 202 is accessed and locally stored on the receiver user device. One skilled in the relevant arts will recognize that step 648 can be accomplished by various methods within user device 102, in accordance with an embodiment of the present invention. The process then proceeds to step 618.

At step 618 of flowchart 600, the client service, on the user device 102, determines if the data 202 is geographical location restricted, geo-fenced. If the data 202 is geographical location restricted, geo-fenced, the process proceeds to step 640, which is described in more detail below. If the data 202 is not geographical location restricted, geo-fenced, the process proceeds to step 630, which is illustrated and described in more detail in FIG. 6B.

At step 640 of flowchart 600, the client service, on the user device 102, determines if the receiver user device 102 is within the restricted geographical location, geo-fence. If the receiver user device 102 is within the restricted geographical location, geo-fence, the process proceeds to step 620, which is described in more detail below. If the receiver user device 102 is not within the restricted geographical location, geo-fence, the process proceeds to step 630, which is illustrated and described in more detail in FIG. 6B.

At step 620 of flowchart 600, the client service, on the user device 102, creates an outside geo-fence alert, then the process proceeds to step 612, which is described in more detail above.

The method continues in FIG. 6B at step 630 of flowchart 600 from step 618 and 640, the client service, on the user device 102, determines if the data 202 was successfully accessed and stored locally, as previously illustrated in FIG. 6A. One skilled in the relevant arts will recognize that step 630 can be accomplished by various methods within user device 102, in accordance with an embodiment of the present invention. If the data 202 is successfully accessed and stored, the process proceeds to step 632, which is described in more detail below. If the data 202 is not successfully accessed and stored, the process proceeds to step 634.

At step 632 of flowchart 600, the client service, on the user device 102, creates a successful read alert, then the process proceeds to step 612, which is described in more detail above.

At step 634 of flowchart 600, the client service, on the user device 102, creates an unsuccessful read alert, then the process proceeds to step 612, which is described in more detail above.

At step 624 of flowchart 600, the client service, on the user device 102, determines if the data 202 is amended meta data sent from the data delivery storage system 106. If the data 202 is meta data sent from the data delivery storage system 106, the process proceeds to step 626, which is described in more detail below. If the data 202 is not amended meta data sent from the data delivery system 106, the process proceeds to step 622.

At step 622 of flowchart 600, the client service, on the user device 102, signals that the information has been received and gets stored.

At step 626 of flowchart 600, the client service, on the user device 102, stores the amended meta data 202, then the process proceeds to step 628.

At step 628 of flowchart 600, the client service, on user device 102, accesses allocated resources on the data delivery storage system 106 and stores data 202 (binary, ASCII, or any file type). One skilled in the relevant arts will recognize that step 628 can be accomplished by various methods within user device 102, in accordance with an embodiment of the present invention. The process proceeds to step 636.

At step 636 of flowchart 600, the client service, on the user device 102, determines if the data 202 (binary, ASCII, or any file type) was successfully accessed and stored locally. One skilled in the relevant arts will recognize that step 636 can be accomplished by various methods within user device 102, in accordance with an embodiment of the present invention. If the data 202 is successfully written, the process proceeds to step 654, which is described in more detail below. If the data 202 is not successfully written, the process proceeds to step 638.

At step 638 of flowchart 600, the client service, on the user device 102, creates a failed write alert, then the process proceeds to step 612, which is described in more detail above.

At step 654 of flowchart 600, the client service, on the user device 102, creates an successful write alert, then the process proceeds to step 612, which is described in more detail above.

### VII. User Device Data Usage

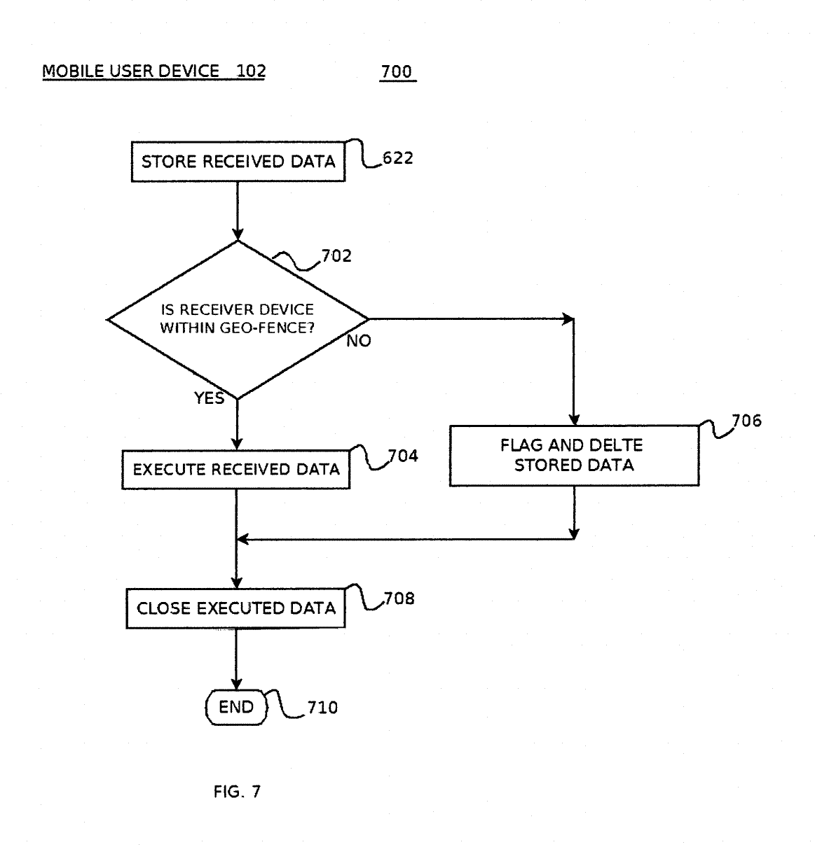

FIG. 7 is a flowchart 700 depicting an operational flow of data on the user device 102, in accordance with an embodiment of the present invention, for the handling of received data 202 (binary, ASCII, or any file type). As previously illustrated in FIG. 6A and FIG. 6B, operational flow of the client service on the user device 102, step 622 signals that a data 202 has been received and stores the received data 202. One skilled in the relevant arts will recognize that step 622 can be accomplished by various methods within user device 102, in accordance with an embodiment of the present invention. The process then proceeds to step 702.

At step 702 of flowchart 700, determines if the receiver user device 102 is within the restricted geographical location, geo-fence. If the receiver user device 102 is within the restricted geographical location, geo-fence, the process proceeds to step 704, which is described in more detail below. If the receiver user device 102 is not within the restricted geographical location, geo-fence, the process proceeds to step 706, which is described in more detail below.

At step 704 of flowchart 700, demonstrates the user device 102 executing the stored data 202. The process then proceeds to step 708, which is described in more detail below.

At step 706 of flowchart 700, the mark and delete the received stored data 202 for deletion on the user device 102. One skilled in the relevant arts will recognize that step 706 can be accomplished by various methods within user device 102, in accordance with an embodiment of the present invention. The process then proceeds to step 708.

At step 708 of flowchart 700 the user device 102 closes executed data 202, then proceeds to the end at step 710, in accordance with an embodiment of the present invention.

### IX. Advantages

From the description above, a number of advantages of some embodiments of my sender controlled geographical location fencing method become evident:

(a) The sender of the data can maintain control over which geographical location the intended receiver may roam into, in order to and be granted viewing, and or access privileges on the sent data.

(b) The receiver of the data no longer has equal control over the accessed data, as the sender. The sender has superior, and sometimes sole control over the sent data.

(c) The sender can send data other than text messages, such as binary, ASCII, or any file type.

(d) The sender has knowledge that the intended receiver has roamed into a restricted geographical location.

(e) The sender device is the creator and owner of the data, as such, the sender dictates the which geographical location the data may existence. Not some other entity.

### X. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

I claim:

1. A method for deleting data initiated by a remote sender user device, the method comprising: A method of a data sender, having quarantined the sent data to a geographical location defined by the sender, resulting in the one or more remote devices not be able to receive the sent data, as they have entered a geographical location that is outside of the data sender's defined geographical limits comprising the steps of:
a. a sender device creating data;
b. a sender sending the data from the sender device, wherein the created data has an unique identifier, wherein the unique identifier is a tag for subsequent location and the quarantining geographically location information is preloaded in the user created data;
c. the sender authenticating a destination user or user device, wherein a search is performed to determine one or more properties associated with a valid user;
d. receiving the created data on one or more remote devices, wherein the created data is stored on the one or more remote devices, with preloaded quarantining geographically location information;
e. the one or more remote devices verifying the receipt of the created data, wherein the unique identifier of the created data is verified by the sender device.

2. The method of claim 1, wherein the step of the sender sending the data further comprising the steps of:
a. a data delivery storage facilitating transmission of the data over the wireless network from the sender device to the one or more remote devices, wherein the data delivery storage is in communication with the sender device and the one or more remote devices;
b. the data delivery storage parsing the created data, wherein the one or more remote devices is identified by a token within the parsed data, wherein the quarantining geographically location information within the parsed data is stored, wherein the created data is repackaged;
c. the data delivery storage routing the created data between the sender device and the one or more remote devices.

3. The method according to claim 1, wherein the step of receiving the data further comprises of authenticating the sender device by comparing a unique properties of the sender device to registered values for the unique properties.

4. The method according to claim 3, wherein the sender device is a mobile phone, a sensor, or an Internet of Things (IoT) device, and further wherein the unique properties comprise of a phone number, or media access control address (MAC), or any combination of unique device attributes.

5. The method according to claim 1, further comprising the step of: comparing the unique properties of the remote user device to registered values for the unique properties.

6. The method according to claim 5, wherein the one or more remote devices is a mobile phone, a sensor, or an Internet of Things (IoT) device, and further wherein the unique properties comprise at least a phone number, or a media access control address (MAC), or any of the unique device attributes.

7. The method according to claim 1, further comprising the step of receiving a data executed alert to the sender device.

8. The method according to claim 1, wherein the step of quarantining the sent data to a geographical location defined by the sender, further comprises the steps of:
a. a data delivery storage determining a number of the one or more remote devices that accessed the created data;
b. a data delivery storage determining which of the one or more remote devices is outside the sender defined geographical location that attempt to access the created data, wherein the created data is not accessible, wherein unique identified stored data is deleted, and wherein an outside geo-fence alert is forwarded to the sender device;
c. a receiver device attempts to execute a locally stored data, while physically located outside the defined geographical location, results in uniquely identified stored data being deleted a from the receiver device.

9. The method according to claim 1, further comprising the step of receiving a outside geo-fence alert on the sender device.
